(19) United States
(12) Patent Application Publication
(10) Pub. No.: US 2011/0281252 A1
(43) Pub. Date: Nov. 17, 2011

(54) METHODS AND SYSTEMS FOR REDUCING THE NUMBER OF TEXTBOOKS USED IN EDUCATIONAL SETTINGS

(76) Inventors: Shefali A. Pandya, El Dorado Hills, CA (US); Hammad A. Bashir, El Dorado Hills, CA (US); Ravi A. Pandya, El Dorado Hills, CA (US); Nishita Vijay Jain, El Dorado Hills, CA (US); Sangsoo Kim, El Dorado Hills, CA (US); Justin Waiming Voo, El Dorado Hills, CA (US)

(21) Appl. No.: 12/777,460

(22) Filed: May 11, 2010

(51) Int. Cl. G09B 7/00; A47B 39/00

(52) U.S. Cl. 434/325; 434/432

(57) ABSTRACT

A classroom configuration is described that includes a computer having a wireless communications interface and a plurality of student workstations. The workstations each include a work surface, a projecting device mounted proximate the work surface and operable for projecting images onto the work surface, a light emitting device, a tracking device mounted proximate the work surface and operable for capturing the image projected onto the work surface and for tracking movement of the light emitting device, and a processing device communicatively coupled to the projecting device and the tracking device. The processing device includes an interface operable for communicating with the computer via the communications interface. At least one of the processing device and the computer are programmed to receive data associated with movement of the light emitting device via the tracking device and the processing device and generate data, for transmission to the projector via the processing device, the generated data indicative of the movement of the light emitting device for transmission onto the work surface and the projected image by the projecting device.

### BACKGROUND OF THE INVENTION

The field of the invention relates generally to a technology-based educational computer system, and more specifically, to methods and systems for reducing the number of textbooks used in educational settings.

Currently, most educational systems utilize traditional paper textbooks as a means to convey information to students. This educational methodology has been essentially unchanged for hundreds of years. As a result, the typical student today carries a heavy backpack containing these textbooks to and from school. One study documented that on average, a student backpack weighs around ten pounds. Some student backpacks weigh up to forty pounds.

The textbook method, while physically cumbersome as described above, is also expensive. For example, the cost of textbooks for the government of California is about 450 million dollars annually.

The current education system suffers from severe budget shortfalls that are causing several state governments to lay-off teachers. For example, in fiscal year 2009, the State of California had to lay-off around 25,000 teachers. The current economic situation is exacerbating these budgetary problems.

### BRIEF DESCRIPTION OF THE INVENTION

In one aspect, a classroom configuration is provided that includes a computer comprising a wireless communications interface and a plurality of student workstations. Each workstation includes a work surface, a projecting device mounted proximate the work surface and operable for projecting images onto the work surface, a light emitting device, a tracking device mounted proximate the work surface and operable for capturing the image projected onto the work surface and for tracking movement of the light emitting device, and a processing device communicatively coupled to the projecting device and the tracking device. The processing device includes an interface operable for communicating with the computer via the communications interface. At least one of the processing device and the computer are programmed to receive data associated with movement of the light emitting device via the tracking device and the processing device and generate data, for transmission to the projector via the processing device, the generated data indicative of the movement of the light emitting device for transmission onto the work surface and the projected image by the projecting device.

In another aspect, a method for implementing a technology-based classroom environment is provided. The method includes utilizing a projector, mounted proximate a student work surface, to project images from at least one of a digital textbook, a student selected source, and a teacher selected source onto the student work surface, capturing, using a tracking device mounted proximate the student work surface, student entries made on the work surface with a light emitting device, associating a position of the entries with a portion of the projected image, and causing the entries to be projected onto the work surface along with the projected image.

In still another aspect, a student workstation is provided. the workstation includes a work surface, a projection device mounted proximate the workstation and operable to project an image onto the work surface, a tracking device mounted proximate the workstation and operable to track movement of a light emitting device with respect to the work surface, a processing device programmed to control operation of the projection device and the tracking device, and a memory operable to interface with the processing device. The processing device is programmed to cause the projection device to project an image onto the work surface and cause the tracking device to capture movement of the light emitting device in response to the projected image with respect to the work surface for storage in the memory.

### BRIEF DESCRIPTION OF THE DRAWINGS

FIG. 1 is a basic block diagram of a technology-based educational system.

FIG. 2 is a diagram of a classroom which incorporates multiple of the projector and camera systems of FIG. 1, those systems being in bidirectional communications with an instructor computer.

FIG. 3 is a flowchart depicting a method for implementing a technology-based educational system.

FIG. 4 is a basic block diagram of a technology-based educational system illustrating a projection system and tracking system operable from an underside of a student worksurface.

### DETAILED DESCRIPTION OF THE INVENTION

The described embodiments generally relate to creating a substantially paperless educational solution. The described solutions utilize projection devices along with image capturing devices along with computing hardware and software. Such embodiments solve the issues arising from paper textbooks by a highly innovative and cost effective solution using advances in projection, imaging, and computing technologies. As will be further described, the described embodiments substantially eliminate the need for students to carry heavy backpacks filled with textbooks, notebooks, and more to and from school. For example, when utilizing a technology-based educational solution as described herein, students may only need to carry a flash drive or equivalent to and from school. As is known, such devices have a storage capacity for many textbooks and student notebooks. In alternative embodiments, students may not even be required to carry a flash drive, as internet based storage services are becoming more prevalent, and the contents of the textbooks may be stored on an external server which the students can access from any computer including, for example home computers, using a password or other security mechanism.

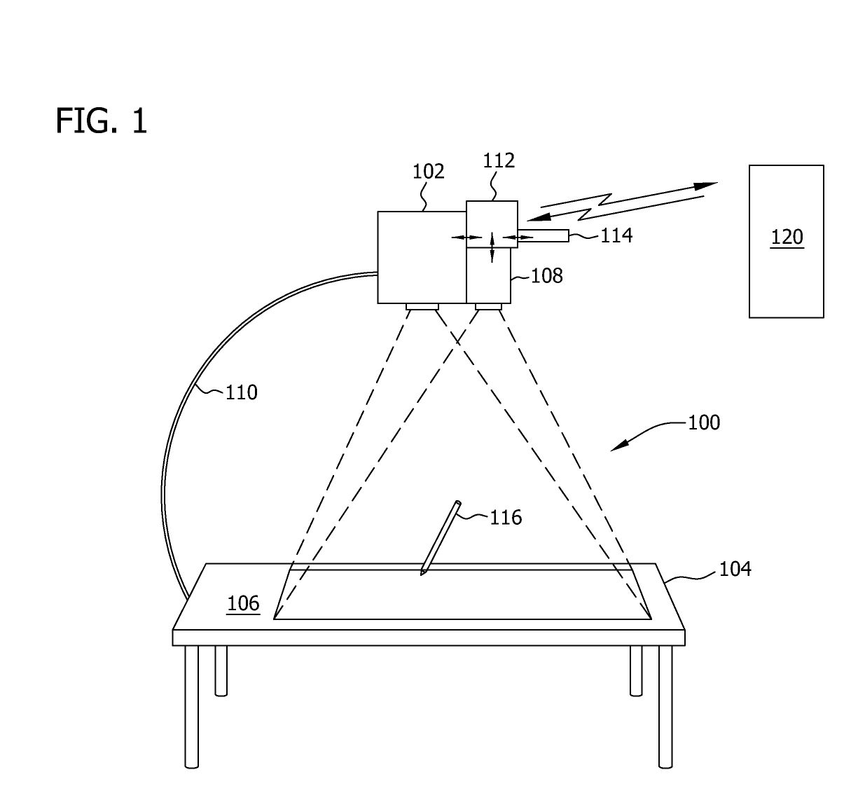

Referring now to FIG. 1, a basic block diagram of the paperless school system 100 is provided. System 100 includes a projection device, for example a PICO projector 102, attached to a student desk 104 such that it will project images down onto a surface 106 of the student desk 104. An infrared tracking system (e.g., camera) 108 mounted proximate the PICO projector 102, and a mounting apparatus 110 extends between the student desk 104 and the PICO projector 102 for the mounting of the PICO projector 102 with respect to the desk 104. In the illustrated embodiment, a processing device 112 is communicatively coupled to projector 102 and camera 108. A flash drive 114, or other portable memory device is included as part of system 100. In the illustrated embodiment, flash drive 114 is configured to interface with processing device 112, for example, through a universal serial bus (USB) connection. The flash drive 114 is capable of storage of data such that it is operable for the storage of the content of many textbooks. The processing device 112 operates, for example and in one embodiment, as a controller for projector 102 and camera 108 and as described further, as a communications interface for external devices. An infrared pen 116 is also included, and its functionality is explained in following paragraphs.

It should be noted that while system 100 is described herein as having a processing device 112 and an interface to a portable memory (flash drive 114) many other configurations of system 100 are possible. For example, processing capabilities and external communications capabilities may be built into one or both of projector 102 and camera 108. In addition, the processing device 112 may be representative, for example, of a computer such as a laptop computer that is located at a student's desk 104 and communicatively coupled, for example, with computer cabling run through mounting apparatus 110 to projector 102 and camera 108 to provide the functionality described herein. In an alternative embodiment, the processing device may be an embedded device, such as a microcontroller, providing a minimal processing capability. In one such example, processing device 112 may be a microcontroller-based stand alone device programmed to perform only a subset of the functions described herein.

In the embodiment shown in FIG. 1, the PICO projector 102, through processing device 112, is communicatively coupled to a computer 120 in either a wired or wireless configuration. With respect to such an embodiment, an operator, such as a teacher, is capable of operating computer 120 such that it sends messages destined for projector 102, which is then operable to transmit an image (based on the messages) onto a surface of the desk 104. In response to the image, a student at desk 104 may utilize the pen 116 to enter a response to the image. For example, the image may take the form of a question, with a blank space for entering an answer. The student may enter the answer in the blank space with the infrared device (pen 116) whose movement can be recognized by camera 108, for example using handwriting recognition software. Upon an indication from the student that the answer is complete, the camera 108 will capture the image transmitted onto the desk, combine that image with portions of the image added by the student using the pen 116, and send it to the main computer 120 via processing device 112, and/or store the combination of images and student entries in flash device 114 for future access. In regard to the handwriting recognition software, it may be run on the individual processing devices 112 or on the operating computer 120.

In the illustrated embodiment, camera 108 communicates with computer 120 via processing device 112, but in alternative embodiments, the communications between camera 108 and computer 120 (and between projector 102 and computer 120) may be direct. The described embodiments may easily be expanded to include computers in a virtual network, and handwriting recognition software that creates the interactivity of a touch screen on every student's desk 104. Continuing with a further example, the projector 108 projects an image onto a student's desk 104 where the student can mark up the image, effectively taking notes. The student's notes are sensed by camera 108, and may be subsequently converted to computer-based text using handwriting recognition software running on the networked computers, for example, computer 120 or processing device 112. The students take notes using infrared pen 116, whose motion is detected by infrared camera 108 or alternatively a strategically placed set of infrared cameras. This note taking information is passed, for example, to computer 120, which projects the information, including student notes, onto the student's desk using the PICO projector 102. In addition, for future reference, the marked up image and any recognized text may also be stored within the memory device 114 or an external server (not shown in FIG. 1) which a student can later access, for example, using a computer located within their home that has an internet capability.

Generally, PICO projector 102 is a handheld type of projector, which is sometimes referred to as a pocket projector or a mobile projector. Such projectors are part of an emerging technology that applies the use of a projector in a handheld device. Such projectors have been developed in response to the emergence of compact portable devices such as mobile phones, personal digital assistants, and digital cameras, which have sufficient storage capacity to handle presentation materials but little space to accommodate an attached display screen. Handheld projectors involve miniaturized hardware and software that can project digital images onto any nearby viewing surface, such as a wall. These projectors generally include four main parts: supporting electronics, laser light sources, combiner optics, and scanning mirrors. First, the electronics system turns the image into an electronic signal. Next the electronic signals drive laser light sources with different colors and intensities down different paths. In the combiner optics, the different light paths are combined into one path demonstrating a pallet of colors. Finally, the mirrors copy the image pixel by pixel and can then project the image. In most embodiments, this entire system is compacted into one chip. An important design characteristic of a handheld projector is the ability to project a clear image, regardless of the physical characteristics of the viewing surface.

Referring further to the components of system 100 included in FIG. 1, the PICO projector 102 is attached by mounting apparatus 110 to each student's desk 104. Each projector 102 has a red, green and blue laser projector that further includes a mirror. Such a laser based system requires no focus, and it is bright enough to be seen in daylight, while not harming the students' eyes. System 100 further includes a removable flash storage 114 to hold the contents of many textbooks, in either image form, text form, or a combination of the two. The projector 102 projects an image directly onto any surface, in the illustrated embodiment, the surface 106 of the student's desk 104. Based on student or instructor input, the image may be a selected page, or pages, from one or more of the textbooks stored in computer memory. In one contemplated embodiment, multiple projectors 102 are connected in a virtual network to computer 120 via wired or wireless connections. Such a network configuration allows one actual, physical computer 120 to control multiple projectors 102, thereby reducing the number of computers 120 needed while still allowing each student to have his or her own workspace.

The images projected by projector 102 create the interactivity of a touch screen directly on the student's desk 104 through use of the infrared camera 108. In one classroom scenario, each student is equipped with their own system 100, and each student will therefore have the infrared pen 116 or other device that can be tracked by camera 108. Each individual camera 108 detects the infrared light emitted from the corresponding pen 116 or other device, and where it is with respect to the image on the desktop. As mentioned above, computer 120 is operable to trace the pen's 116 movements in relation to the desktop, and the handwriting will be converted into text using handwriting recognition software. In embodiments, the movements of the pen 116 may be interpreted as entering input into a virtual keyboard, for example, whose image is projected onto the work surface 106. In embodiments, an actual keyboard may be utilized to provide student input to computer 120.

In addition, teachers are able to pass out digital assignments as well as tests. Students can complete their assignments directly, using device 100, as well as take notes to be stored as images or computer text in digital textbooks or even digital paper, which in embodiments is a projected image which may be blank (or with previously written notes) on which the student takes notes and subsequently stores such notes within a computer. In regard to the described embodiments, a notebook page equivalent to a textbook page is projected onto the student's desk. The utilization of digital paper can effectively remove the need for students to carry notebooks and hence serves the purpose of notebook paper but is digital or virtual.

The above described solution is advantageous to other approaches such as e-books and laptops. First, incorporation of the projector 102 and camera 108 within system 100 is a less expensive solution, as low level laptop computers and standard electronic-readers are more expensive than the projector and camera system, without even considering the cost of digital textbooks. It is further expected that the cost of the projector and camera system 100 will continue to decrease, including the cost of digital textbooks. Another advantage of the projector and camera system is that handwriting, and therefore handwriting recognition, is not possible on e-readers, and on laptops typing can become cumbersome. Also, there is the problem of the student carrying around a device such as a laptop computer, which can be broken. In the education solution that implements system 100, the only device the student may have to transport is a flash drive 114 or other portable memory device and possibly, an infrared pen. Lastly, the screens on e-readers and laptops are relatively small, whereas the projector systems described herein have a projection size of up to 60 inches.

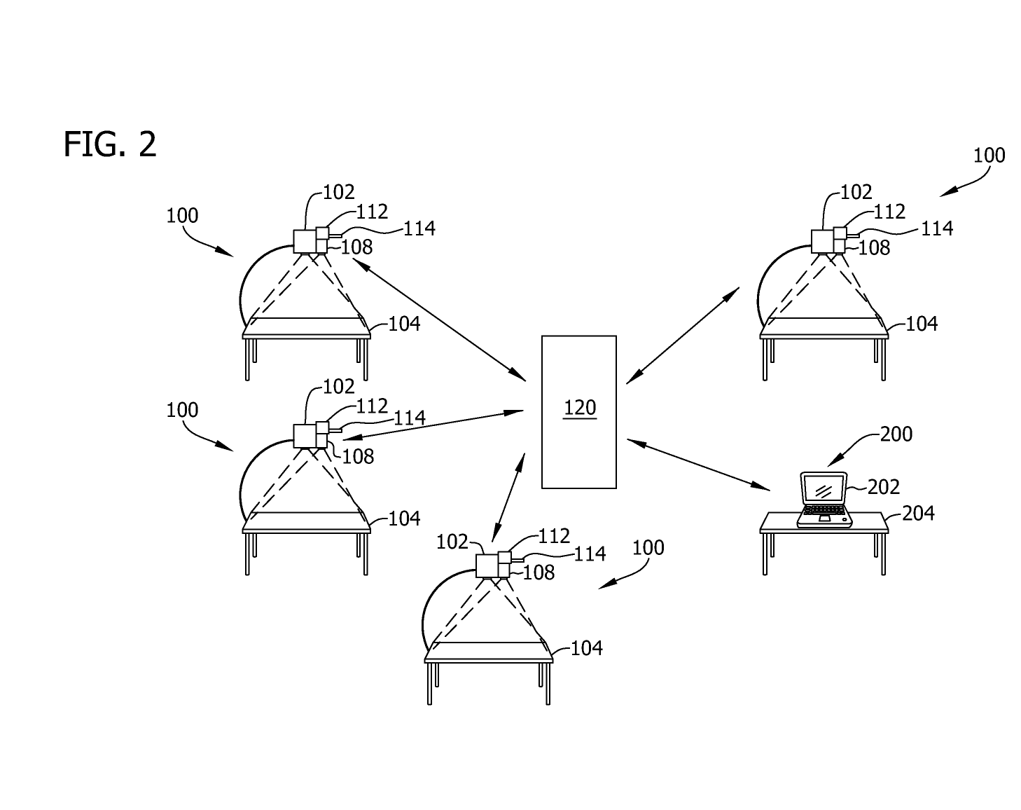

FIG. 2 is a diagram of a classroom which incorporates multiple of the projector and camera systems 100 described above, the systems 100 being in bidirectional communications with computer 120 as is also described above. For the classroom environment, a teacher system 200 is also shown as being in bidirectional communications with computer 120. In one easy to understand scenario, the teacher system 200 would include a user interface 202 at a teacher's desk 204 where the teacher can initiate and monitor the described interactions between the individual students at their corresponding systems 100 and computer 120. As is easily understood, the teacher system 200 is operable to cause a specific image, for example part of a lesson plan, to be displayed by each student's projector and camera system 100.

In another embodiment, system 100 is programmed to cause an image of a computer keyboard to be displayed on the student's desk. In such an embodiment, the infrared pen 116 may be utilized in conjunction with the keyboard image to provide a student's input into the system 100. Stated more simply, the pen 116 is tracked by camera 108 to determine which keyboard key images are being selected by a student. Other embodiments, such as a glove that includes infrared material on the fingertips may be used to “engage” the keyboard image or other embodiment of light recognition material may be utilized. Finally, a physical keyboard may be plugged into the processing device 112 or a wireless keyboard may be configured to operate with a system 100.

The students each utilize a projector 102 that projects an image comparable to the user interface displayed at user interface 202 as setup through teacher system 200, and sent through a wired or wireless connection. Each infrared camera 108 is operable to detect the light emitted from the corresponding infrared pen 116 and send such data to the computer 120. The computer 120, for example via a wireless connection, receives tracking data from the individual infrared cameras 108 and then applies the tracking data to the defined space of the “screen” (as determined by a four point calibration, which defines the boundaries of the “screen”).

In one embodiment, infrared pen 116 includes an infrared diode placed at the tip of a pen form-factor, which, when pressure is applied thereto, emits light within the infrared spectrum. The light emitted from the pens 116 can then be tracked by the corresponding infrared cameras 108 with respect to the desk. This is the tracking information that is sent to the computer 120 or processing device 112 for further processing and subsequent display as an image on the student's desk. This tracked light from each individual system 100 is combined with the image projected by computer 120 and the combined image is projected onto the individual student desk surface 106, and the student is able to read the notes, and other marks they have made upon the image with the infrared pen in substantially real time. In addition, in one scenario, the infrared pen 116 may be utilized in providing an input to system 100 to access particular data, for example, the student may utilize pen 116 in such a fashion that signals emanating from the pen 116 are captured by camera 108 and utilized to cause a specific page of a textbook in the memory of computer 120 or in memory device 114 to be projected through projector 102 and onto the desk 104. In another application, the pen 116 may be utilized to generate signals that are captured by camera 108, upon system start up, and utilize such signals as an attempted entry of a password, enabling one or more of the functions described herein.

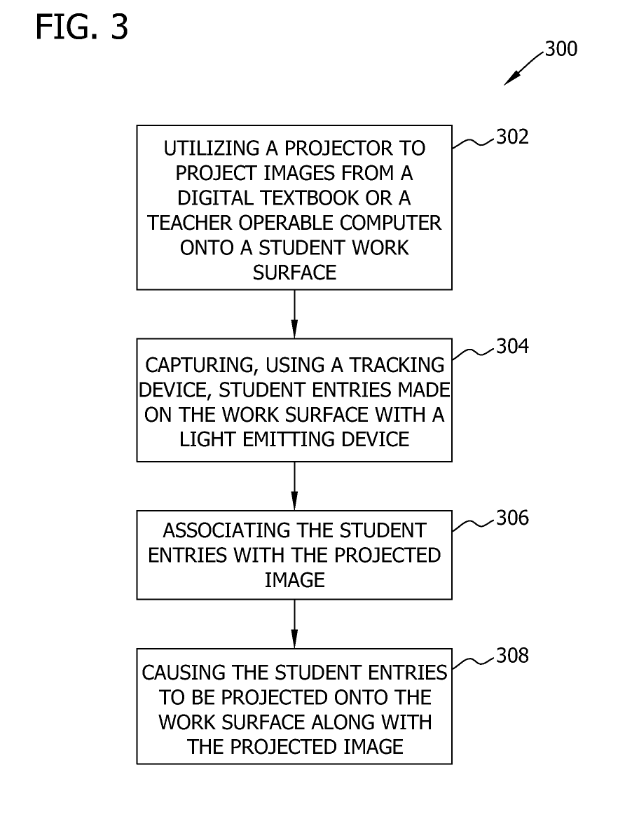

As will be easily understood by those skilled in the art, the above described embodiments enable a method for implementing a reduced paper, technology-based classroom, as shown in the flowchart 300 of FIG. 3. The method includes, in one embodiment, utilizing a projector, suspended over a student work surface, to project 302 images from one of a digital textbook and a teacher operable computer onto the student work surface. Student entries made on the work surface with a light emitting device are then captured 304, using a tracking device suspended over the student work surface. A position of the entries is associated 306 with a portion of the image, and the entries are then projected 308 onto the work surface and thus combined with the projected 302 image. In such a method, the student entries may be stored along with the image in a memory for subsequent retrieval and projection, including for future study by the student. Additionally, such entries and images may be stored in a memory accessible by the teacher associated with the classroom environment.

Additionally, for students without access to a computer within their home, system 100 can be programmed with a functionality that allows the student to printout relevant assignment documents, complete the assignment on the paper while at home, and then scan the completed paper documents using camera 108 upon their return to school. Handwriting recognition software may be utilized to convert student handwritten entries to text that can be accessed, for example, by a teacher that made the original assignment.

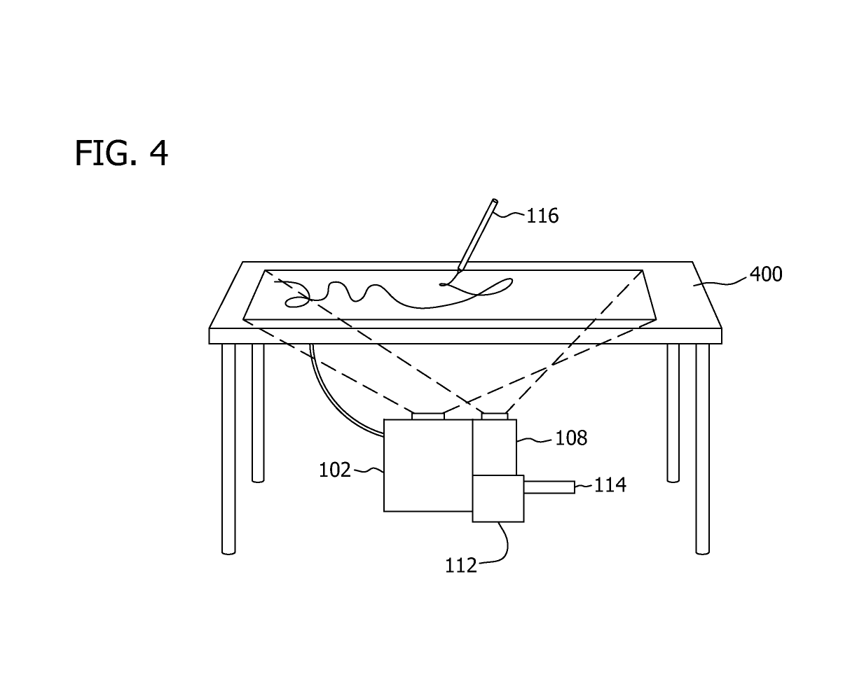

In the above described embodiments, the projector 102 and camera 108 are described as being above a work surface such that images can be projected onto the work surface 106 and such that movements of a light emitting pen can be tracked, for example, in response to those projected images. Further embodiments are considered in which a transparent student work surface 400 is utilized as is shown in FIG. 4. In such embodiments, one or both of the projector 102 and camera 108 (for capture of pen movement) may be done from below the transparent surface through mounting of such components below the work surface 400 as shown. Other components are as described with respect to FIG. 1. In such embodiments, a benefit is attained since the system does not have to compensate for the presence of the students hand on the work surface.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A classroom configuration comprising:
a computer comprising a communications interface; and
a plurality of student workstations each comprising:
a work surface;
a projecting device mounted proximate said work surface and operable for projecting images onto said work surface;
a light emitting device;
a tracking device mounted proximate said work surface and operable for capturing the image projected onto said work surface and for tracking movement of said light emitting device; and
a processing device communicatively coupled to said projecting device and said tracking device, said processing device comprising an interface operable for communicating with said computer via said communications interface, at least one of said processing device and said computer programmed to receive data associated with movement of said light emitting device via said tracking device and said processing device and generate data, for transmission to said projector via said processing device, the generated data indicative of the movement of the light emitting device for transmission onto said work surface and the projected image by said projecting device.

2. A classroom configuration according to claim 1 further comprising a plurality of portable memory devices, each said portable memory device associated with a corresponding said workstation, said portable memory devices each comprising an interface to a corresponding said processing device.

3. A classroom configuration according to claim 1 wherein one of said projecting device and said tracking device comprises said processing device.

4. A classroom configuration according to claim 1 wherein said computer is operable to cause said projecting device to project an image onto said work surface based on an input to said computer by a user of said computer.

5. A classroom configuration according to claim 1 wherein said workstations are operable to cause said tracking device to capture an image projected onto said work surface and upload the captured image to at least one of a portable memory device, said computer, and an external storage device based on an input to said workstation by a user of said workstation.

6. A classroom configuration according to claim 1 further comprising:
a plurality of portable memory devices, each said portable memory device associated with a corresponding said workstation; and
a server, said server accessible from remote computers using a password recognition capability stored in said portable memory devices.

7. A method for implementing a technology-based classroom environment, said method comprising:
utilizing a projector, mounted proximate a student work surface, to project images from at least one of a digital textbook, a student selected source, and a teacher selected source onto the student work surface;
capturing, using a tracking device mounted proximate the student work surface, student entries made on the work surface with a light emitting device;
associating a position of the entries with a portion of the projected image; and
causing the entries to be projected onto the work surface along with the projected image.

8. A method according to claim 7 further comprising storing the student entries within the image in a memory for subsequent retrieval and projection.

9. A method according to claim 8 further comprising combining the image and the student entries prior to storage in the memory.

10. A method according to claim 7 wherein capturing student entries made on the work surface further comprises using a handwriting recognition capability to convert inputs received by the tracking device into computer-based text.

11. A method according to claim 7 further comprising:
utilizing the projector to transmit an image of a computer keyboard onto the work surface;
capturing movements of the light emitting device on the keyboard image with the tracking device; and
converting the captured movements into data representing entry into a computer keyboard.

12. A method according to claim 7 further comprising capturing movements of the light emitting device to determine which page of a textbook stored in a memory should be projected onto the work surface.

13. A method according to claim 7 further comprising causing the entries to be to be stored in a memory accessible by the teacher associated with the classroom environment.

14. A method according to claim 7 further comprising:
printing the projected images onto paper as an assignment; and
scanning the completed paper assignment using the tracking device; and
forwarding the scanned image to a memory for access by a teacher.

15. A student workstation comprising:
a work surface;
a projection device mounted proximate said workstation and operable to project an image onto said work surface;
a tracking device mounted proximate said workstation and operable to track movement of a light emitting device with respect to said work surface;
a processing device programmed to control operation of said projection device and said tracking device; and
a memory operable to interface with said processing device, said processing device programmed to cause said projection device to project an image onto said work surface and cause said tracking device to capture movement of the light emitting device in response to the projected image with respect to said work surface for storage in said memory.

16. A student workstation according to claim 15 wherein said memory comprises at least one of:
a flash memory device that may be physically detached from said workstation for utilization with another processing device; and
an internet based storage service.

17. A student workstation according to claim 15 comprising handwriting recognition software operable for converting the physical movement of the light emitting device into computer text.

18. A student workstation according to claim 15 wherein said processing device comprises a wireless interface, said processing device programmed to generate data based on movement of said light emitting device as captured by said tracking device, and send the generated data to an external system via said wireless interface.

19. A student workstation according to claim 15 wherein said processing device comprises a wireless interface, said processing device programmed to receive data via said wireless interface and cause the received data to be projected as an image onto said work surface.

20. A student workstation according to claim 15 wherein said tracking device comprises an infrared camera and said light emitting device comprises an infrared pen.

21. A student workstation according to claim 15 wherein said processing device is programmed with password protection, said processing device programmed, upon start up, to utilize an input received from said tracking device, tracking movement of a light emitting device, as a password entry attempt.

22. A student workstation according to claim 15 wherein said processing device is programmed, upon receipt of a command, to:
cause said projection device to project an image of a computer keyboard onto said work surface; and
recognize subsequent movements of the light emitting device, as captured by said tracking device, as inputs into said workstation based on the projected keyboard image.

23. A student workstation according to claim 15 wherein said memory comprises an electronic version of at least one textbook stored therein.

24. A student workstation according to claim 15 wherein:
said work surface comprises a transparent work surface; and
said projection device is mounted under said work surface and configured to project the images onto an underside of said transparent work surface.

25. A student workstation according to claim 24 wherein said tracking device is operable for tracking movement of the light emitting device from one of a top side and an underside of said transparent work surface.

26. A student workstation according to claim 15 wherein:
said work surface comprises a transparent work surface;
said projection device is mounted above said work surface and configured to project the images onto a top of said transparent work surface; and
said tracking device is operable for tracking movement of the light emitting device from one of a top side and an underside of said transparent work surface.
